(19) United States
(12) Patent Application Publication
(10) Pub. No.: US 2020/0329694 A1
(43) Pub. Date: Oct. 22, 2020

(54) SPRINKLER CONTROLLER CAPABLE OF REPELLING ANIMAL

(71) Applicant: AEON MATRIX INC., Taipei City (TW)

(72) Inventor: Ming-Je Tsai, Taipei City (TW)

(21) Appl. No.: 16/390,152

(22) Filed: Apr. 22, 2019

(51) Int. Cl. A01M 29/30; G06K 9/00; G06T 7/20

(52) U.S. Cl. CPC A01M 29/30; G06K 9/00369; G06F 3/04847; G06T 7/20; G06T 2207/30232; G06K 9/00771

(57) ABSTRACT

A sprinkler controller capable of repelling an animal is illustrated and has an image capturing unit and a processing unit. The image capturing unit is used to capture images of a space. The processing unit electrically connected to the image capturing unit is used to analyze the images to determine whether an animal invades a specific zone which is selected or defined by a user in advance, and control a sprinkler unit in the specific zone to sprinkle in response to a determined result.

### BACKGROUND OF THE INVENTION

### 1. Field of the Invention

The present disclosure relates to a sprinkler controller and, in particular, to a sprinkler controller capable of repelling an animal.

### 2. Description of the Related Art

People managing yards, lawns or gardens suffer from the problem that animals may enter into their territories and eat the plants grown therein. Various solutions have been developed to solve this problem. For example, a stand-alone device repelling animals by emitting flashing LED lights has been developed. The device uses a distance sensor to detect the invasion of animals, and activates the LED lights when an animal invasion is detected. Another solution utilizes an ultrasonic generator to emit high-frequency soundwaves which is silent to most humans to repel invading animals. The high-frequency soundwaves may be emitted constantly, and may be adjusted to specific frequency ranges to repel specific animals.

### BRIEF SUMMARY OF THE INVENTION

The present disclosure provides a sprinkler controller capable of repelling an animal. The sprinkler controller comprises an image capturing unit and a processing unit. The image capturing unit is used to capture images of a space. The processing unit electrically connected to the image capturing unit is used to analyze the images to determine whether an animal invades a specific zone which is selected or defined by a user in advance, and control a sprinkler unit in the specific zone to sprinkle in response to a determined result.

Optionally, the processing unit performs a motion detection to determine whether the animal invades the specific zone.

Optionally, the sprinkler unit sprinkles for a period.

Optionally, the period is 30 second.

Optionally, the sprinkler system further comprises a storage unit electrically connected to the processing unit, wherein the storage unit is used to store a video which has a duration, and the processing unit records the video in response to the determined result.

Optionally, the video is formed by the images which are captured in next and previous half durations of a time of detecting that the animal invades the specific zone.

Optionally, the duration is 30 seconds.

Optionally, the sprinkler controller further comprises a communication unit electrically connected to the processing unit and linked to a user terminal device of the user via a wireless or wired communication manner, wherein the processing unit sends warning information to the user terminal device in response to the determined result.

Optionally, the processing unit provides a graphical user interface to the user terminal device, and the user selects or defines the specific zone via the graphical user interface.

Optionally, the controller controls a valve of the sprinkler unit in the specific zone to be turned on/off, such that the sprinkler unit in the specific zone sprinkles when the valve of the sprinkler unit in the specific zone is turned on.

Optionally, the image capturing unit comprises a wide-angle lens camera and an assistant exposure unit.

The present disclosure provides a method of repelling an animal, executed in a sprinkler controller, comprising: capturing images of a space; analyzing the image to determine whether an animal invades a specific zone which is selected or defined by a user in advance; and controlling a sprinkler unit in the specific zone to sprinkle in response to a determined result.

To sum up, by using the provided sprinkler controller and the method of repelling the animal, the sprinkler units can be controlled to not only water the plants, but also have the ability of repelling the animal. Moreover, compared to the infrared sensor for detecting whether the animal invades the specific zone, analyzing the images to detect whether the animal invades the specific zone is more precise, thus preventing the sprinkler unit from falsely sprinkling.

### BRIEF DESCRIPTION OF THE DRAWINGS

In order that the present disclosure may be better understood and readily carried into effect, certain embodiments of the present disclosure are now described with reference to the accompanying drawings, wherein:

FIG. 1 is a schematic usage diagram showing a sprinkler controller capable of repelling an animal according to an embodiment of the present disclosure.

FIG. 2 is a block diagram of a sprinkler controller according to an embodiment of the present disclosure.

FIG. 3 is a schematic diagram of a graphical user interface for selecting a specific zone according to an embodiment of the present disclosure.

FIG. 4 is a flow chart of a method capable of repelling an animal according to an embodiment of the present disclosure.

### DETAILED DESCRIPTION OF THE INVENTION

To make it easier for the examiner to understand the objects, characteristics and effects of this present disclosure, embodiments together with the attached drawings for the detailed description of the present disclosure are provided.

The present disclosure provides a method and a sprinkler controller capable of repelling an animal based on image analysis. In the present disclosure, the sprinkler controller capture images, analyzes the images to determine whether the animal invades a specific zone which is selected and defined by a user, and controls a sprinkler unit to sprinkle for a period according to a determined result which convey information whether the animal invades the specific zone.

The above descriptions illustrate a brief concept of the sprinkler controller and the method of repelling the animal, which are provided by the present disclosure, and the detailed implementations will be illustrated as follows accompanying with drawings.

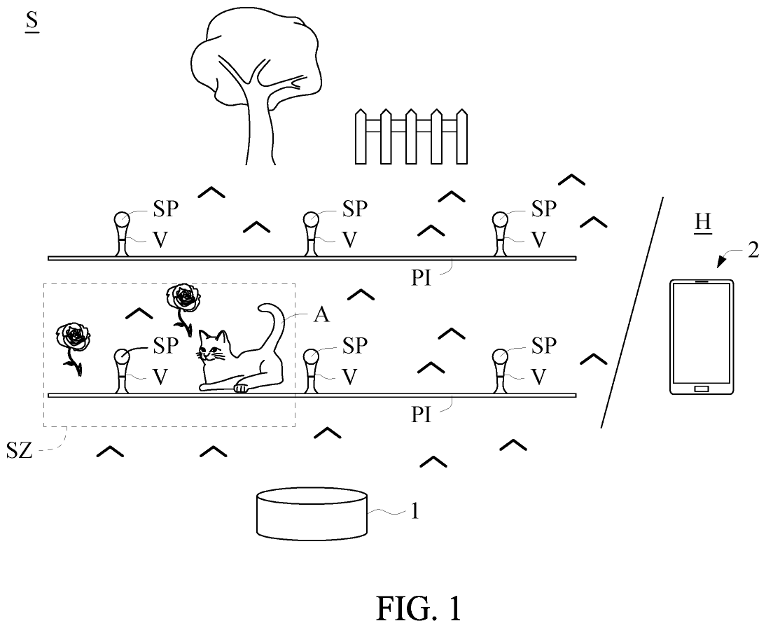

FIG. 1 is a schematic usage diagram showing a sprinkler controller capable of repelling an animal according to an embodiment of the present disclosure. In FIG. 1, the sprinkler controller 1 is disposed in front of a space S. The space S may be any kind of spaces, such as a garden, a farm, a pasture or a camp.

A user is located at a house H and operates a user terminal device 2, such as a smart phone, and the type of the user terminal device 2 is not used to limit of the present disclosure. The house H is located in or near the space S, but the present disclosure is not limited thereto, i.e. the house H in another embodiment may be far away from the space S. The user terminal device 2 is linked to the sprinkler controller 1 via a wireless or wired communication manner.

A plurality of pipes PI are buried under the ground of the space S. The pipes PI are connected a water supply, and the water supply supplies water to the pipes PI. A plurality of sprinkler units SP are connected to the pipes PI, and each the sprinkler unit SP has a valve V disposed in the sprinkler unit SP. The valve V of each the sprinkler unit SP can be controlled to be turned on/off, such that the sprinkler unit SP can sprinkle when the valve V of the sprinkler unit SP is turned on. The valve V of each the sprinkler unit SP is controlled by the sprinkler controller 1, and the valve V of each the sprinkler unit SP is electrically connected to the sprinkler controller 1 via an electrical wire, or alternatively, is linked to the sprinkler controller 1 via a wireless communication manner.

The sprinkler controller 1 can capture images of the space S, and the user can determine a specific zone SZ in the space S. In one example, the images are analyzed by the sprinkler controller 1 by a motion detection mechanism to determine whether an animal A invades the specific zone SZ, and a determined result indicating whether the animal A invades the specific zone SZ is used to generate a control signal to the sprinkler unit SP in the specific zone SZ. In another example, a captured image can be analyzed by object detection algorithm. The control signal is generated as long as an object is detected in one of the captured image.

When the animal A invades the specific zone SZ, the sprinkler controller 1 controls the valve V of the sprinkler unit SP in the specific zone SZ to be turned on for a period, such as 30 seconds, and thus the sprinkler unit SP in the specific zone SZ can sprinkle for the period. That is, the sprinkler controller 1 controls sprinkler unit SP in the specific zone SZ to sprinkle for the period in response to the determined result.

Further, when the sprinkler controller 1 controls the sprinkler unit SP in the specific zone SZ to sprinkle for repelling the animal A, the sprinkler controller 1 can send warning information to the user terminal device 2 to notify the user that the animal invades the specific zone SZ. Meanwhile, the sprinkler controller 1 records a video which has a duration, such as 30 seconds, after the detection of the animal A in the specific zone SZ. Moreover, via the user terminal device 2, a graphical user interface is provided to the user to determine the specific zone in advance.

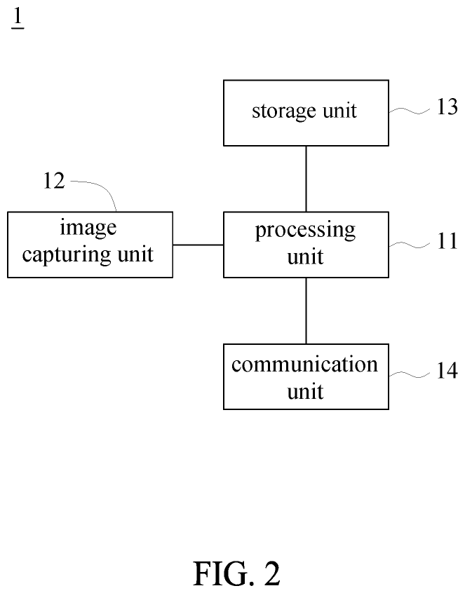

FIG. 2 is a block diagram of a sprinkler controller according to an embodiment of the present disclosure. The sprinkler controller 1 includes a processing unit 11, an image capturing unit 12, a storage unit 13 and a communication unit 14, wherein the processing unit 11 is electrically connected to the image capturing unit 12, the storage unit 13 and the communication unit 14.

The image capturing unit 12 includes a camera, which is used to capture the images of the space S. Further, to increase exposure of the images, the image capturing unit can further comprises an assistant exposure unit. The processing unit 11 receives the images captured by the image capturing unit 14. The processing unit 11 analyzes the images to determine whether the animal A invades the specific zone SZ, and the processing unit generates a control signal to control the sprinkler unit SP in the specific zone SZ according to the determined result.

The storage unit 13 is for storing the images and/or the video captured by the image capturing unit 14. In one example, the storage unit 13 may be non-volatile memory built-in in the sprinkler controller 1. In another example, the storage unit 13 may be a memory card or any detachable memory device that can be attached to the sprinkler controller 1.

The communication unit 14 is for establish the data connection link between the sprinkler controller 1 and the user terminal device 2 via the wireless or wired communication manner, such as IEEE 802.11a/b/g, Bluetooth® or Ethernet. In one example, the communication unit 14 communicates with a server through an 802.11 wireless router disposed in the house H, and the user terminal 2 communicates with that server via telecommunication services. The server receives the data sent from the communication unit 14, and forward the data to the user terminal device 2. That is, the data connection link between the sprinkler controller 1 and the user terminal device 2 is established via the server.

When the processing unit 11 controls the sprinkler unit SP in the specific zone SZ to sprinkle for repelling the animal A, the processing unit 11 further generate the warning information to the communication unit 14, such that the communication unit 14 can send the warning information to the user terminal device 2 via the data connection link.

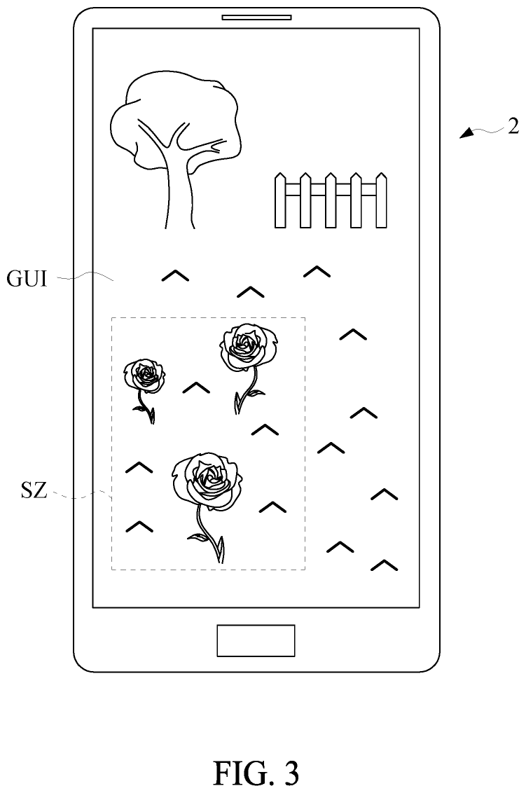

Referring to FIG. 3, which is a schematic diagram of a graphical user interface for selecting a specific zone according to another embodiment of the present disclosure. As shown in FIG. 3, the user terminal device 2 can provide the graphical user interface GUI to the user terminal device 2, such that the user can select or define the specific zone via the graphical user interface in advance. For example. The user terminal device 2 can show an image of the space S to the user, divide the space S into two zones, and receive the selection of the zone by tapping on the graphical user interface GUI to define the specific zone SZ. In another example, the user terminal device 2 receives a rectangle drawn by the user on the graphical user interface to define the specific zone. The user can select multiple specific zones, and for that case the sprinkler unit SP will be activated when an animal intrusion is detected in any one of the specific zones.

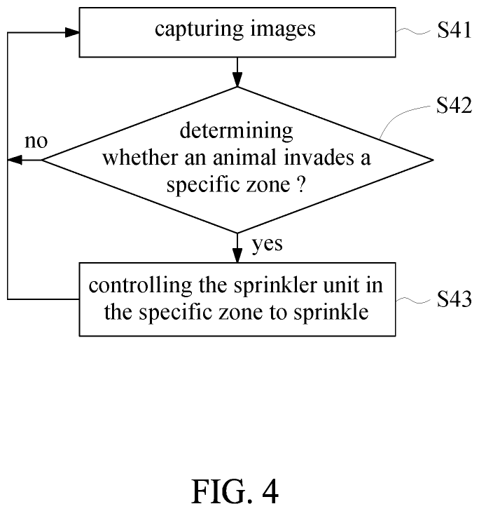

Finally, referring to FIG. 4, FIG. 4 is a flow chart of a method executed in a sprinkler controller capable of repelling an animal according to an embodiment of the present disclosure. At step S41, an image capturing unit is used to capture images of a space.

At step S42, the images are analyzed (such as, performing a motion detection to carry out the analysis) to determine whether an animal invades the specific zone. At step S43, when the animal invades the specific zone, the sprinkler unit in the specific zone is controlled to sprinkle for repelling the invading animal, and that is, the sprinkler unit the specific zone is controlled to sprinkle in response to a determined result.

Furthermore, the method of repelling the animal A further includes a step of recording a video in response to the determined result, and a step of sending warning information to a user terminal device in response to the determined result, wherein the above two steps and step S43 can be executed simultaneously, but the present disclosure is not limited thereto.

Accordingly, regarding the provided sprinkler controller and method, the image capturing unit is used to capture images of the space, the images are analyzed to determine whether the animal invades the specific zone which is selected or defined by the user in advance, and the sprinkler unit in the specific zone is controlled to sprinkle for repelling animal when the determined result indicates that the animal invades the specific zone. Compared to the infrared sensor (p.s. sensitive to the thermal noise) for detecting whether the animal invades the specific zone, analyzing the images to determine whether the animal invades the specific zone is more precise, thus preventing the sprinkler unit in the specific zone from falsely sprinkling. By the way, the architecture of the sprinkler controller is simple, but not complex, thus having the advantage of massive manufacturing.

While the present disclosure has been described by means of specific embodiments, numerous modifications and variations could be made thereto by those skilled in the art without departing from the scope and spirit of the present disclosure set forth in the claims.

What is claimed is:

1. A sprinkler controller capable of repelling an animal, comprising:
an image capturing unit; and
a processing unit electrically connected to the image capturing unit,
wherein the image capturing unit is capable of capturing an image of a specific zone defined by a user in advance, and
wherein the processing unit is capable of analyzing the image to determine whether an animal invades the specific zone, and activating a sprinkler unit in the specific zone in response to a determined result.

2. The sprinkler controller according to claim 1, wherein the processing unit performs a motion detection to determine whether the animal invades the specific zone.

3. The sprinkler controller according to claim 1, wherein the sprinkler unit sprinkles for a period.

4. The sprinkler controller according to claim 3, wherein the period is 30 seconds.

5. The sprinkler controller according to claim 1, further comprising:
a communication unit electrically connected to the processing unit and linked to a user terminal device of the user via a wireless or wired communication manner;
wherein the processing unit sends warning information to the user terminal device in response to the determined result.

6. The sprinkler controller according to claim 5, wherein the user terminal device provides a graphical user interface for the user to define the specific zone via the graphical user interface.

7. The sprinkler controller according to claim 1, wherein the controller controls a valve of the sprinkler unit in the specific zone to be turned on/off, such that the sprinkler unit in the specific zone sprinkles when the valve of the sprinkler unit in the specific zone is turned on.

8. A method of repelling an animal, executed in a sprinkler controller, comprising:
capturing an image of a specific zone defined by a user in advance;
analyzing the image to determine whether an animal invades the specific zone which is selected or defined by a user in advance; and
activating a sprinkler unit in the specific zone in response to a determined result.

9. A non-transitory storage medium having instructions recorded thereon which, when executed by a processor, cause a sprinkler controller to perform the steps of:
capturing an image of a specific zone defined by a user in advance;
analyzing the image to determine whether an animal invades the specific zone which is selected or defined by a user in advance; and
activating a sprinkler unit in the specific zone in response to a determined result.
